(19) United States
(12) Patent Application Publication
(10) Pub. No.: US 2026/0117575 A1
(43) Pub. Date: Apr. 30, 2026

(54) OVERTRAVEL HINGE PRE-OPENER FOR MANUAL FORCE REDUCTION

(71) Applicant: The Braun Corporation, Winamac, IN (US)

(72) Inventors: Robert Earl Bettcher, III, Winamac, IN (US); Nathan L. Martindale, Star City, IN (US); Timothy S. Barber, Winamac, IN (US)

(73) Assignee: The Braun Corporation, Winamac, IN (US)

(21) Appl. No.: 19/363,317

(22) Filed: Oct. 20, 2025

Related U.S. Application Data
(60) Provisional application No. 63/711,382, filed on Oct. 24, 2024.

(51) Int. Cl. E05D 15/10; B60J 5/06

(52) U.S. Cl. CPC E05D 15/101; B60J 5/062; E05Y 2900/531

(57) ABSTRACT

Improvements to an extendable overtravel hinge for a sliding door of a passenger vehicle are provided. One improvement comprises a pre-opening mechanism that moves the overtravel hinge to a partially expanded position prior to the overtravel hinge reaching an open end of a door track. Other improvements comprise provisions to reduce, eliminate, or redirect forces exerted on the track when transitioning the extendable hinge door from a collapsed or the partially expanded condition to a fully expanded condition at the open end of the track.

### CROSS REFERENCE TO OTHER APPLICATIONS

This application claims priority to U.S. Provisional Patent Application No. 63/711,382 filed on Oct. 24, 2024, the content of which is incorporated by reference. This application also incorporates by reference U.S. Pat. No. 10,676,974 B2, published on Jun. 9, 2020.

### FIELD OF THE DISCLOSURE

The present disclosure relates generally to a passenger vehicle that has been modified to allow access by a physically limited passenger, including an overtravel hinge that increases the width of a sliding door opening, and more particularly to methods for mitigating forces during manual operation of the sliding door.

### BACKGROUND

This section introduces aspects that may help facilitate a better understanding of the disclosure. Accordingly, these statements are to be read in this light and are not to be understood as admissions about what is or is not prior art.

Automobile manufacturers do not currently mass-produce passenger motor vehicles specifically designed to transport passengers having physical limitations, either as a driver or as a non-driving passenger. Consequently, mass-produced passenger vehicles are modified, or retrofitted, by a number of aftermarket companies dedicated to supplying vehicles to physically limited passengers. Such vehicles can be modified by removing certain parts or structures within a vehicle and replacing those parts with parts specifically designed to accommodate the physically limited passenger. The equipment that may be fitted to an accessible vehicle includes, but is not limited to, wheelchair access devices such as a ramp or lift, lift platforms, swivel chairs, and lowered floor surfaces.

In some instances, a door opening of an original equipment manufacturer (OEM) van is enlarged or otherwise modified to permit entry and exit of the physically limited individual. In a retrofitted van, the sliding side door moves toward the back of the vehicle to open a passenger entrance as well as to provide access to a ramp, which may be located beneath the floor. In some vehicles, which are considered as viable candidates for retrofitting, the construction of the OEM vehicle requires modification to accommodate the addition of a ramp. Not only must a subfloor be added, but the door opening needs to be widened to provide space for the width of the ramp. Many times, the vehicle modifier will extend the length of the door track, which allows the OEM hinge to travel further in the track and allows the door to open further than originally designed. However, the design of some vehicles, such as the Chrysler Pacifica, does not permit one or more door tracks to be lengthened without expensive body modifications. In such cases, there is a known modification to an OEM vehicle to provide wider access through the sliding door using what is sometimes referred to as an overtravel hinge.

The overtravel hinge attaches to the OEM vehicle door as a replacement for the OEM door hinge and slides in the OEM vehicle track. The hinge provides the door with additional travel to move the door out of the opening, widening the opening such that a wide ramp can fit through the opening. There are some limitations to this overtravel hinge. The opening of the door is a two-step process where the door slides from the closed position at one end of the track until the overtravel hinge (in a collapsed state) reaches a stop at the other end of the track. Once the hinge has hit the stop, then the hinge is extended/expanded to move the door even further than the OEM hinge. During power operation of the sliding door, and particularly the second step of operation when the overtravel hinge moves from the collapsed to expanded state, the motor that operates the door applies the force along an axis generally aligned with the path of motion of the door; however, during manual operation of the sliding door, the application of the force to open the door on the door handle by the operator is generally transverse or oblique to the path of motion of the door such that it creates translational forces and moments within the system that could cause damage or failing components. Therefore, there exists a need to reduce the forces that could cause damage to the hinge or other vehicle components.

### SUMMARY OF THE EMBODIMENTS

In one embodiment of the present disclosure, a modified accessible vehicle including a chassis, a track coupled to the chassis, and a door operatively connected to the track is outfitted with an extendable hinge assembly coupled to the door and movably coupled to the track. The track comprises a first end and a second end: the door being in the closed position when the sliding assembly is located at the first end; the door being in the open position when the sliding assembly is located at the second end. The extendable hinge assembly includes a first bracket coupled to the door, a second bracket coupled to the first bracket at a first pin, a third bracket coupled to the second bracket at a second pin, a support bracket coupled to the third bracket at a third pin, and a sliding assembly coupled to the support bracket and adapted to move along the track. The extendable hinge assembly may have at least a collapsed configuration, partially expanded configuration, and fully expanded configuration. The extendable hinge assembly may further include at least one biasing mechanism configured to bias the extendable hinge assembly to the collapse configuration. The biasing mechanism may be a torsion spring coupled to at least one of the pins and configured to contact the brackets of the extendable hinge assembly. The extendable hinge assembly may additionally have an arm coupled between the third pin and the second pin. The arm may substantially complete a four-bar mechanism between the first bracket, second bracket, third bracket, and the arm. The four-bar mechanism may assist with controlling the expansion of the extendable hinge.

The sliding assembly comprises at least one rolling member configured to roll along the track as the door moves between the open and closed positions. In the first configuration, the door is in its closed position, the hinge assembly is at the first end of the track in the collapsed position. In the second configuration, the door is located between the open and closed positions, the third bracket is pivoted outwardly and arranged substantially perpendicular to the support bracket, and the second bracket extends outwardly in a substantially perpendicular position relative the track. In the third configuration, the door is located in the open position, the hinge assembly is at the second end of the track, and the extendable hinge assembly is in the fully expanded configuration.

In another embodiment, the force required to transition the extendable hinge assembly to the fully expanded configuration is reduced through the addition of a pre-open mechanism. The pre-open mechanism may include a cam coupled to the support bracket and a cam engaging feature coupled to the first bracket of the extendable hinge assembly. Alternatively, the cam may be configured to contact a protrusion of the first bracket or any other existing structure of the extendable hinge assembly. Further, the cam may be a protrusion of the support bracket. As the door moves away from the closed position at the first end of the track, the support bracket rotates relative to the first bracket. During such rotation, the cam may come into contact with the cam engaging feature. The cam and cam engaging feature may have leading edges to gradually engage with each other. The contact between the cam and the cam engaging feature may result in the first bracket being pushed outwardly away from the third bracket to transition the hinge assembly to the partially expanded configuration.

In another example of this embodiment, a pre-opening bracket is mounted to the support bracket such that it protrudes away from the sliding assembly. The pre-opening bracket may include one or more rollers, rubber bushings, low-friction plastic parts, or any other soft material that allows sliding motion. As the door moves away from the closed position at the first end of the track, the support bracket rotates relative to the door. During such rotation, the pre-opening bracket rotates with the support bracket and the one or more rollers contact an inside face of the door to push the door outwards from the vehicle. This outward pushing of the door pushes the first bracket away from the third bracket to transition the hinge assembly to the partially expanded configuration.

In another embodiment, a modified sliding assembly of the extendable hinge is customized to dissipate forces better than the OEM sliding assembly. The OEM roller configuration typically has one or more rollers rotating about a substantially vertical axis positioned to contact a lip and a back wall of the track and prevent the sliding assembly from falling out of the track. The one or more rollers may experience heavy moments during the manual opening of the door. The moment causes forces that can damage the rollers or the track. During the moment, one roller may apply a horizontal force outward on the lip of the track, while another roller may apply a horizontal force in the opposite direction on the back wall of the track. This force could lead to the lip being deformed and reducing the support for the one or more rollers and possibly cause the sliding assembly to fall out of the track. The modified sliding assembly may include one or more rollers that rotate about an angled axis and configured to contact the track in a corner between the lip and a top wall. A larger horizontal roller width was contemplated to reduce the cantilevered force on the track lip; however, the body of the vehicle blocks both ends of the track from sliding the roller assembly in from the end, and taller rollers would hinder installation of sliding the roller assembly in the track. The one or more rollers may have two tapered or conical portions, where the two portions define two roller surfaces that are oriented at an angle to each other meet at an apex. The apex may be configured to correspond to the corner of the track between the lip and the top wall or the corner of the track between the back wall and the top wall.

In an alternative embodiment, a modified sliding assembly of the extendable hinge is customized to dissipate forces better than the OEM sliding assembly via a wedge bracket. The wedge bracket may be installed at the second end of the track. The wedge bracket may have a protrusion with at least a first leading edge. The protrusion may additionally have a second leading edge. A block may be fixedly coupled to the sliding assembly. The block may be configured to engage the wedge bracket. The block may have at least one protrusion. The at least one protrusion may have at least one leading edge configured to engage with the first leading edge of the wedge bracket. The block may additionally have a second leading edge configured to engage with the second leading edge of the wedge bracket. In a specific example, the block may have two protrusions, each having one leading edge to engage with one leading edge of the protrusion of the wedge bracket. The two protrusions of the block may contact the wedge bracket on opposite sides. The opposite side engagement may provide support for the sliding assembly in two opposing directions. The engagement of the block with the wedge bracket prevents the one or more rollers of the sliding assembly from contacting the track and damaging the track.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 illustrates a side view of a modified passenger vehicle including an access ramp.

FIG. 2 illustrates a side view of a modified passenger vehicle having a first, second, and third track adapted to provide for sliding movement of a door from a closed position to an open position.

FIG. 3 illustrates a perspective view of a prior art overtravel hinge in multiple positions along a track.

FIG. 4 illustrates a perspective view of a first embodiment of an improved overtravel hinge in a collapsed and folded state from a first angle.

FIG. 5 illustrates a perspective view of the first embodiment of the improved overtravel hinge in the collapsed state from a second angle.

FIG. 6 illustrates a top view of the first embodiment of the improved overtravel hinge in the collapsed and folded configuration.

FIG. 7 illustrates a top view of the first embodiment of the improved overtravel hinge in the partially expanded and unfolded configuration.

FIG. 8 illustrates a top view of the first embodiment of the improved overtravel hinge in the fully expanded and unfolded configuration.

FIG. 9 illustrates the prior art overtravel hinge in the collapsed and unfolded configuration at the second end of the door track.

FIG. 10 illustrates the first embodiment of the improved overtravel hinge in the partially expanded and unfolded configuration at the second end of the door track.

FIG. 11 illustrates a perspective view of a second embodiment of an improved overtravel hinge in the collapsed and folded configuration.

FIG. 12 illustrates a top view of the second embodiment of the improved overtravel hinge in the collapsed and folded configuration.

FIG. 13 illustrates a top view of the second embodiment of the improved overtravel hinge in the partially expanded and unfolded configuration.

FIG. 14 illustrates a bottom view of an improved sliding assembly for an overtravel hinge.

FIG. 15 illustrates a top view of a wedge bracket configured to engage with the improved sliding assembly of FIG. 14.

FIG. 16 illustrates a perspective view of the improved sliding assembly of FIG. 14 engaged with the wedge bracket of FIG. 15.

FIG. 17 illustrates a perspective of an improved roller assembly that is shown coupled to a prior art bracket support and extendable hinge in a first, collapsed and folded, configuration.

FIG. 18 is a rear view of the improved roller assembly of FIG. 17.

FIG. 19 is a rear view of a prior art roller assembly.

Corresponding reference numerals are used to indicate corresponding parts throughout the several views.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure. Any alterations and further modifications in the described embodiments and any further applications of the principles of the inventions as described herein are contemplated as would normally occur to one skilled in the art. Although a limited number of embodiments are shown and described, it will be apparent to those skilled in the art that some features that are not relevant to the claimed inventions may not be shown for the sake of clarity.

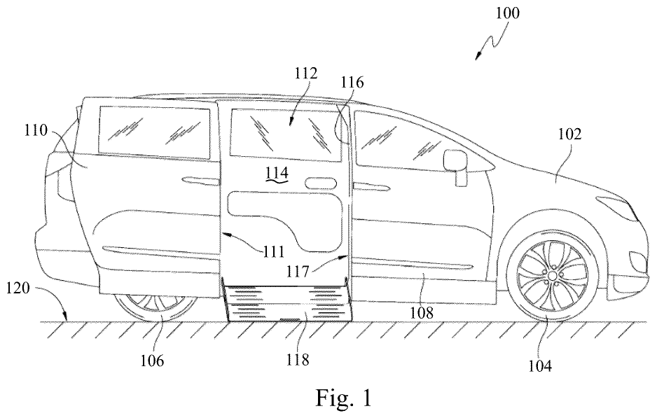

FIG. 1 illustrates a side view of a vehicle 100, commonly identified as a passenger van or minivan, available from any number of United States and foreign manufacturers. In the illustrated embodiment, the vehicle 100 includes a unibody construction, but other vehicles having a frame on body construction, are also included in the present disclosure. Consequently, the use of vehicle herein includes all types and kinds of vehicles with a body on frame construction, a unibody construction, or other constructions. In addition, while vehicle 100 is illustrated as a van in FIG. 1, the present disclosure is directed to all passenger vehicles carrying one or more passengers. For purposes of this application, the vehicle 100 referenced herein is a US market vehicle with left-hand side driving configuration, although it is contemplated that the embodiments described herein could be modified for use with a right hand side driving vehicle.

The vehicle 100 includes a body 102, operatively coupled to front wheels 104 and rear wheels 106. The vehicle 100 has a front row passenger-side door 108 and a second-row passenger-side sliding door 110. The sliding door 110 is coupled to the vehicle 100 through a sliding mechanism including a plurality of tracks, typically three. Other numbers of tracks are possible. When the sliding door 110 is slid towards the rear wheels 106, it provides an opening 112 for access to the interior 114 of the vehicle 100. The opening 112 width is restricted by the edge 117 of B-pillar 116 and the edge 111 of door 110. The opening 112 is modified to be wider than the OEM vehicle 100 configuration. The modified opening 112 provides sufficient width for installation of a ramp 118 to provide access to a wheelchaired passenger. The ramp 118 is installed at the opening 112 and is movable between the interior 114 of the vehicle 100, where it is stored in some embodiments, and to the exterior where is deployed to the ground 120 for wheelchair access.

In known modified vehicles, such as the modified van, the middle row of seats is removed from the manufacturer supplied vehicle to enable access to a wheelchair supporting a passenger. Once the wheelchaired passenger moves into the interior of the vehicle, the passenger or caregiver locates the wheelchair in the middle portion of the interior behind the driver and passenger seats of the front row. As used herein, a wheelchaired passenger is used to indicate that the individual is making use of a wheelchair, whether that use is temporary or permanent.

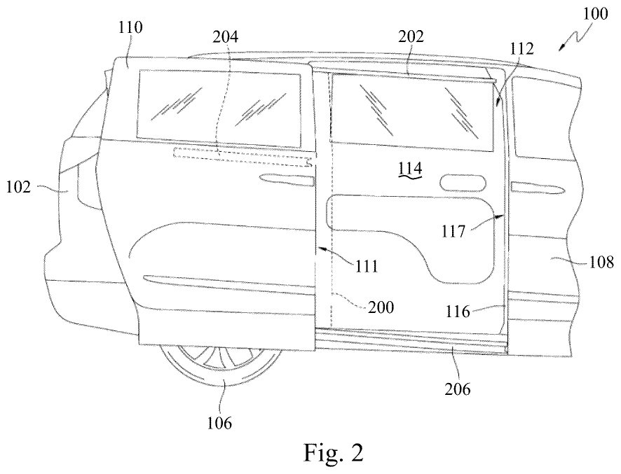

FIG. 2 illustrates the same vehicle 100 as FIG. 1, with more detail to the operation of sliding door 110. The sliding door 110 rides on three tracks, a top track 202, a middle track 204, and a bottom track 206. Each track is adapted to provide sliding movement of the door 110 from a closed position to an open position and back to a closed position as is understood by those skilled in the art. In one embodiment, an upper portion of the body 102 supports the top track 202 and a lower portion of the body 102 supports the bottom track 206. The middle track 204 is supported by the body but is located, in one embodiment, at a bottom portion of a side window. When the OEM hinges are used in the vehicle 100, the size of the opening 112 is established between the edge 117 of the B-pillar 116 and the edge 111 of the door 110 which can open no further than a location 200 as illustrated by the dotted line. In this illustration, the vehicle 100 has been modified to include an extendable hinge configured to open the sliding door 110 further towards the rear wheels 106, providing a larger opening 112 for wheelchaired passenger access.

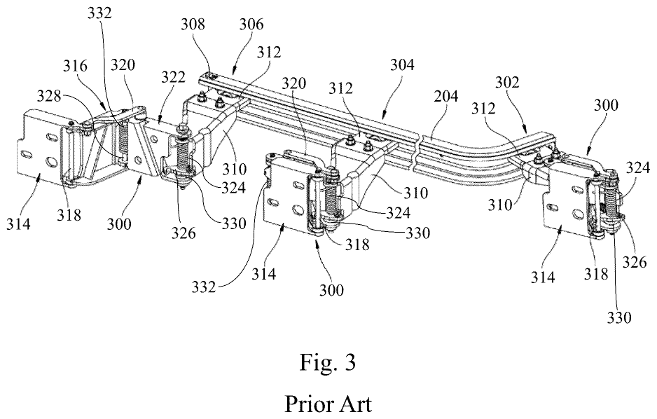

FIG. 3 illustrates a perspective view of a prior art extendable hinge 300 in three configurations at various locations of a sliding door track as the door is moved from the closed position to the open position. In this embodiment, the extendable hinge 300 is pivotably connected to an OEM bracket support 310 which is coupled to an OEM sliding assembly 312, which engages the track 204 to allow sliding movement of the extendable hinge 300 between the two ends of the track. In other embodiments, one or both of the sliding assembly 312 and the bracket support 310 are not an OEM part, but are parts specifically adapted to mate with the extendable hinge 300. The extendable hinge 300 provides increased access area (width) of the door opening 112. The extendable hinge 300 may be utilized on one, some, or all of the tracks 202, 204, and 206. For purposes of the present disclosure, middle track 204 is discussed. In other embodiments, a single extendable hinge 300 is used at the middle track 204 and other hinges, not necessarily the prior art extendable hinge 300, are used for the other tracks.

In the first configuration at the first end 302 of track 204, the extendable hinge 300 is in a collapsed or fully closed configuration, the extendable hinge 300 is in a folded configured relative to the bracket support 310, and the sliding door 110 is closed. In the second configuration at a second location 304 on track 204, the extendable hinge 300 is still in the collapsed configuration; however, the extendable hinge 300 is in an unfolded configuration relative to the bracket support 310 and the sliding door 110 is partially open. Typically, the extendable hinge 300 will possess the second configuration when the hinge 300 is disposed between the first end 302 and second end 306 of the track. In the third configuration at the second end 306 of track 204, the extendable hinge 300 is in a deployed or fully open or expanded/extended, configuration, the extendable hinge 300 is still unfolded relative to the bracket support 310, and the sliding door 110 is open. A stop 308 is located at the second end 306 of the track 204 to stop the extendable hinge 300 from traveling further along the track 204. The stop 308 defines the extent of the OEM open position of the door 110, which is increased by the extendable hinge 300. Typically, once the sliding assembly 312 engages the stop, the extendable hinge 300 moves from the collapsed position to the fully extended condition without further sliding movement along the track 204.

The extendable hinge 300 includes a first bracket 314 configured to attach to the inside of sliding door 110. The first bracket 314 is pivotably coupled to a second bracket 316 at a pin 318. The second bracket 316 is pivotably coupled to a third bracket 322 at a pin 328. The third bracket 322 is pivotably coupled to the bracket support 310 at a pin 330. A first biasing member is a spring 324 coupled to pin 330 and configured to contact the bracket support 310 and the third bracket 322 to bias the extendable hinge 300 from a folded position 300 relative to the bracket support 310 to an unfolded position 304 relative to the bracket support 310. A second biasing member is a spring 332 coupled to pin 328 and configured to contact the second bracket 316 and the third bracket 322. An arm 320 extends along the extendable hinge 300 when the hinge is in the collapsed condition. The arm 320 is pivotably coupled to the first bracket 314 and to the third bracket 322. The arm 320 completes a four-bar mechanism with the first bracket 314, second bracket 316, and third bracket 322. This four-bar mechanism is configured to control the expansion of the extendable hinge 300 between the collapsed configuration at location 304 and the fully expanded configuration at location 306. In some embodiments, the arm 320 may not be required and can be omitted from the overtravel hinge 300. In some embodiments, a latch 326 pivotably coupled to pin 330 may have a notch of a predetermined size sufficient to capture the pin 318. The latch 326 may secure pin 318 to keep the overtravel hinge in the collapsed condition to prevent unwanted expansion of the extendable hinge 300 as the door approaches the closed position.

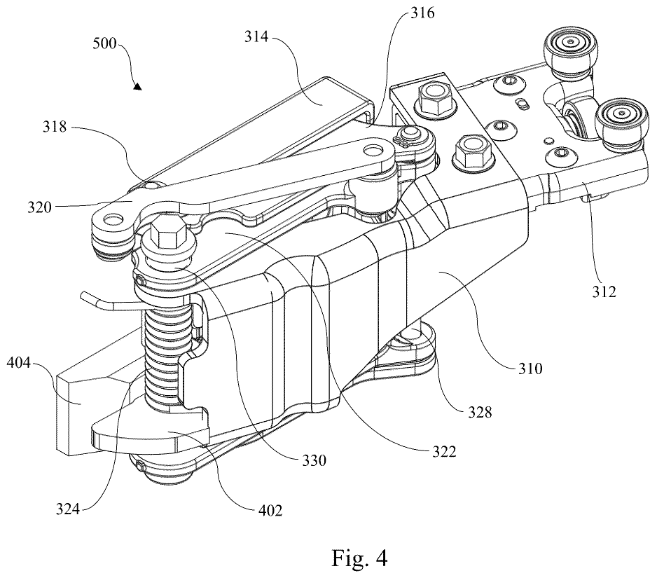

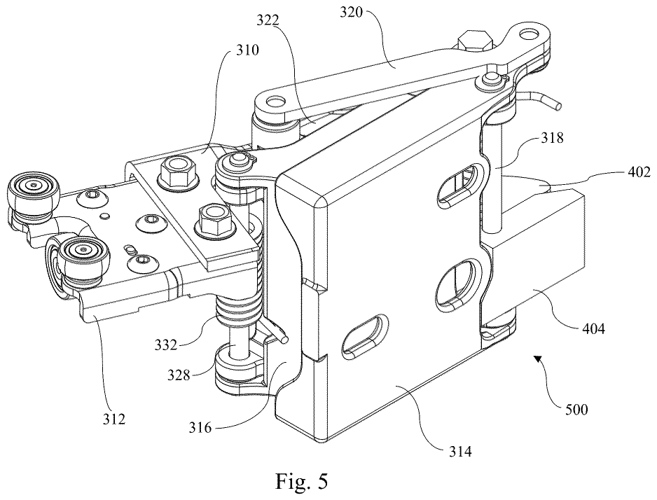

FIGS. 4-5 illustrate perspective views of a first embodiment of an improved extendable hinge 500 pivotably coupled to the bracket support 310. The bracket support 310 is coupled to the sliding assembly 312 configured to linearly travel in the OEM track 204. In these figures, the extendable hinge 500 is shown in the first configuration, folded relative to the bracket support 310 and collapsed. As with the prior art embodiment, the improved extendable hinge 500 includes a third bracket 322 pivotably coupled to the bracket support 310 at pin 330. The second bracket 316 is pivotably coupled to the third bracket 322 at pin 328. The first bracket 314 is pivotably coupled to the second bracket 316 at the pin 318. The first biasing member is spring 324 coupled to pin 330 and configured to contact the bracket support 310 and the third bracket 322 to bias the extendable hinge 500 to the unfolded position relative to the bracket support 310. A second biasing member is a spring 332 coupled to pin 328 and configured to contact the second bracket 316 and the third bracket 322. The arm 320 is pivotably coupled to the first bracket 314 and to a third bracket 322. As previously discussed regarding the prior art extendable hinge 300 in FIG. 3, the latch 326 may be omitted as shown in FIGS. 4-8. The improvement of the extendable hinge 500 presented in FIGS. 4-8 is a pre-open cam 402, which is coupled to the bracket support 310, and pre-open block 404, which is coupled to the first bracket 314.

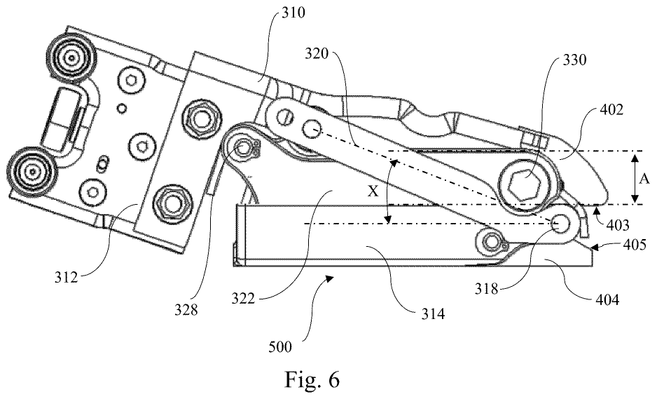

FIGS. 6-8 illustrate top views of the improved extendable hinge 500 of FIGS. 4-5 in three configurations at various locations of a sliding door track as the door is moved from the closed position to the open position. These three configurations and locations correspond to the same three configurations and locations depicted in FIG. 3 for the prior art extendable hinge 300.

In the first configuration at the first end 302 of the track, the extendable hinge 500 will be in a collapsed, or fully closed configuration and will be in a folded configuration relative to the bracket support 310, as shown in FIG. 6, which allows the extendable hinge 500 to fit with an existing cavity or pocket in the vehicle's C-pillar and the door 110 to close. In the collapsed and folded configuration, the pre-open cam 402 and pre-open block 404 are disengaged and/or spaced apart. With the cam 402 and block 404 disengaged, the three brackets 314, 316, 322 of the extendable hinge 500 can fully collapse and/or nest, whereby corresponding sides of the first bracket 314 and third bracket 322 are spaced apart a distance A and arm 320 is oriented at an angle X relative to the first bracket 314.

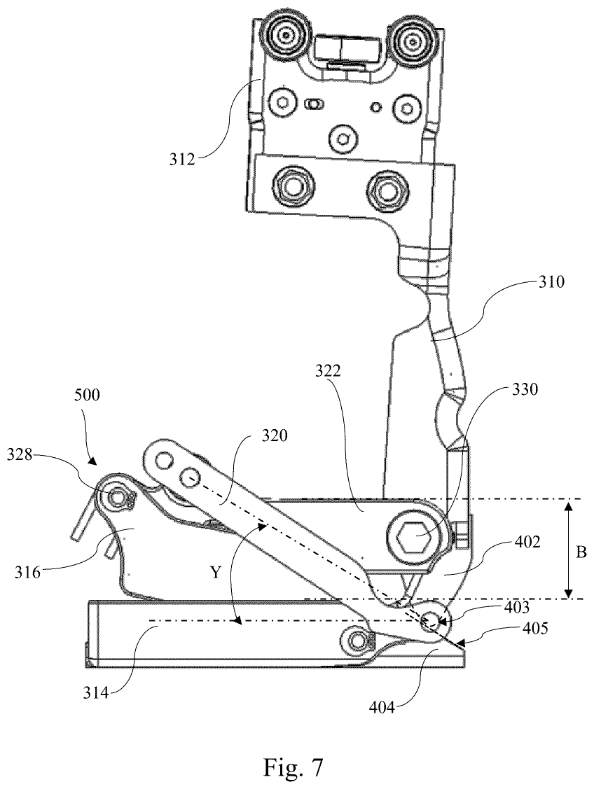

In the second configuration, shown in FIG. 7, the extendable hinge 500 will be in an unfolded configuration relative to the bracket support 310. However, in contrast to the prior art extendable hinge 300, the extendable hinge 500 will be in a partially expanded position in the second configuration, due to engagement between the pre-open cam 402 and pre-open block 404. When the extendable hinge 500 is transitioning from the folded configuration at the first end 310 of the track 204 to the unfolded configuration in the second location 304 on track 204, the bracket support 310 rotates relative to the third bracket 322 about pin 330. As the bracket support 310 rotates, the pre-open cam 402, which is coupled to the bracket support 310, contacts the pre-open block 404, which is coupled to the first bracket 314. With the cam 402 and block 404 engaged, continued rotation of the bracket support 310 to the unfolded position causes the first bracket 314 to be pushed away from the third bracket 322 to the partially expanded position. In the partially expanded position, corresponding sides of the first bracket 314 and third bracket 322 are spaced apart a distance B, which is greater than distance A, and the arm 320 is oriented relative to the first bracket 314 at angle Y, which is greater than angle X. The pre-open cam 402 and pre-open block 404 may have a cam surfaces 403, 405 configured to smoothly engage each other as the bracket support 310 rotates relative to the third bracket 322. The cam surfaces 403, 405 may be profiled such that the distance between the first bracket 314 and third bracket 322 gradually increases the further the bracket support 310 rotates away from the folded position and toward the unfolded position.

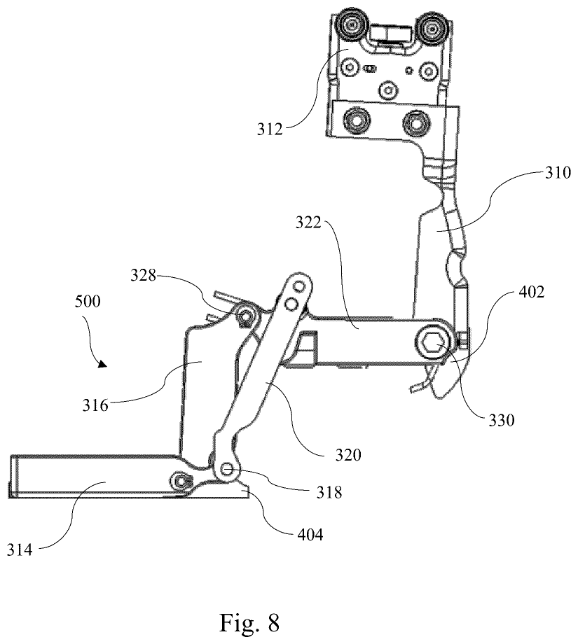

In the third configuration, shown in FIG. 8, the extendable hinge 500 is in the fully extended or expanded position and is in an unfolded configuration relative to the bracket support 310. Notably, the pre-open cam 402 and pre-open block 404 are disengaged in this third configuration and do not interfere with the extendable hinge 500 moving to the fully expanded position.

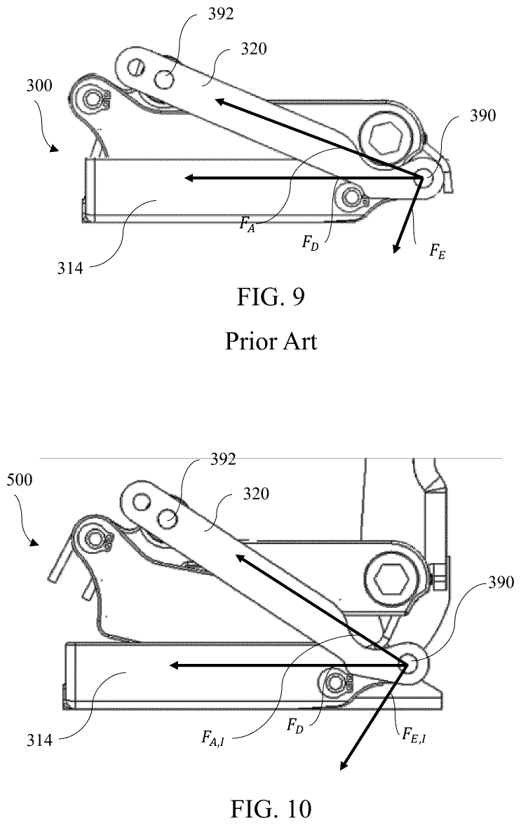

As best illustrated in FIGS. 9-10, the pre-expansion or pre-opening of the extendable hinge 500 to the partially expanded position (whereby arm 320 is oriented at angle Y relative to the first bracket 314) reduces the force required to manually transition the overtravel hinge 500 to the fully expanded configuration at the second end 306 of the track 204, as compared to the force required to manually transition the prior art overtravel hinge 300 from the collapsed position (whereby arm 320 is oriented at angle X relative to the first bracket 314) to the fully expanded configuration. In FIG. 9, the prior art extendable hinge 300 is shown in the collapsed position, just prior to being expanded to the fully expanded position at the second end 306 of the track 204. When manually operating the door 110, the operator applies a force to the handle of door 110, which roughly acts as force Fp on the first bracket 314 at the pivot point 390 between the arm 320 and the first bracket 314. During manual operation of the door 110, the force Fp has a force component FA that acts along the length the arm 320, thereby resisting expansion of the extendable hinge 300 and, more problematic, creating translational forces and moments at the interface between the roller assembly 312 and the track 204. The force FD also has a force component FE that acts perpendicular to the length the arm 320. Force component FE causes arm 320 to rotate about pivot point 392 relative to the third bracket 322, thereby expanding the extendable hinge 300. In FIG. 10, the improved extendable hinge is shown in the partially expanded position, just prior to being further expanded to the fully expanded position at the second end 306 of the track 204. When manually operating the door 110, the operator applies a force to the handle of door 110, which roughly acts as force Fp on the first bracket 314 at the pivot point 390 between the arm 320 and the first bracket 314. During manual operation of the door 110, the force Fp has a force component FA, that acts along the length the arm 320. The force FD also has a force component FE, that acts perpendicular to the length the arm 320. Force component FE, causes arm 320 to rotate about pivot point 392 relative to the third bracket 322, thereby further expanding the improved extendable hinge 500. Notably, due to angle Y being greater than angle X, the force component FAI of the improved extendable hinge 500 is less than the force component FA of the prior art extendable hinge 300, whereby the translational forces and moments at the interface between the roller assembly 312 and the track 204 are reduced. In addition, the force component FEI of the improved extendable hinge 500 is greater than the force component FE of the prior art extendable hinge 300, whereby the amount of force that must be manually applied to the door handle to fully open the door 110 to the overtravel position can be reduced.

While the depicted embodiment of the improved extendable hinge 500 has the pre-open cam 402 coupled to the bracket support 310 and the pre-open block 304 coupled to the first bracket 314, the pre-open block 404 may be an integrated feature of first bracket 314 or the pre-open cam 402 may be configured to contact another component of the hinge assembly 500, such as the pin 318, or the door 110 itself.

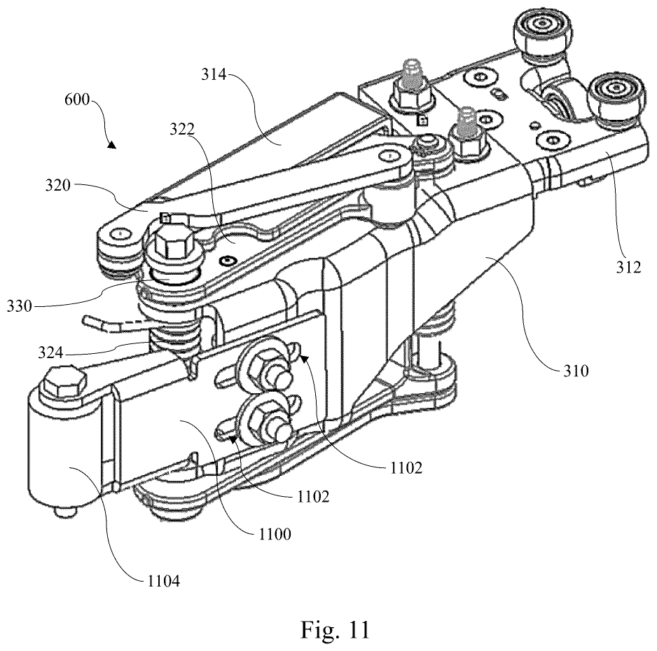

Turning now to FIGS. 11-13, a second embodiment of an improved extendable hinge 600 is depicted. The improvement represented in FIGS. 11-13, as compared to the prior art extendable hinge 300, is a pre-open door bracket 1100 that may be coupled to the bracket support 310. The pre-open door bracket 1100 performs a similar function as the pre-open cam 402 and pre-open block 404 does for the first embodiment of the extendable hinge 500, i.e., moving the extendable hinge 600 to a partially expanded position. A first end pre-open door bracket 1100 may incorporate slots 1102 that allow the pre-open door bracket to be adjustably mounted to the bracket support 310. The adjustable mounting feature provided by slots 1102 may accommodate installation of the extendable hinge 600 on a variety of vehicles and allows customization of the degree to which the extendable hinge 600 is pre-opened. The further the pre-open door bracket 1100 is mounted from the roller assembly 312, the greater the expansion of the extendable hinge 600 in the partially expanded position. A roller 1104 may be rotatably mounted at a free end of the pre-open door bracket 1100 for smooth engagement with an inside surface of the door 110, as hereinafter described. The roller 1104 may be one or more of a low friction plastic bushing, rubber roller, cam followers, rollers, or any other method of a freely rotating outer surface configured about an axis. In alternative embodiments, the roller 1104 may be replaced by a non-rotating flat or profiled slide bearing. In the present disclosure, the roller 1104 is considered to be a single rubber roller with a nylon bushing to reduce rattling noises during vehicle operation.

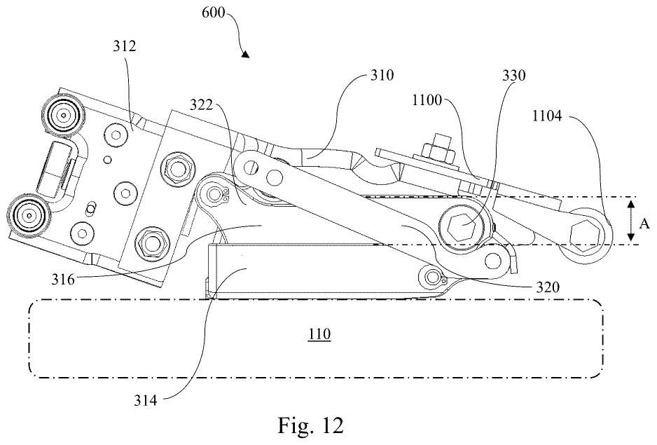

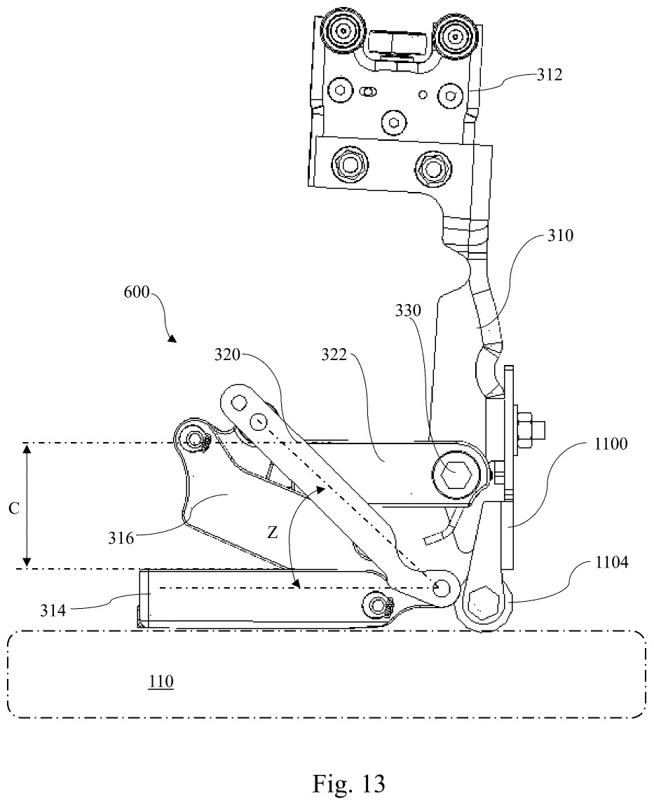

When the extendable hinge 600 is transitioning from the folded configuration at the first end 302 of the track 204 (see, e.g., FIG. 12) to the unfolded configuration at the second location 304 of the track 204 (see, e.g., FIG. 13), the bracket support 310 rotates relative to the extendable hinge 600 (including all three brackets 314, 316, 322) and the door 110 about pin 330. As the bracket 310 rotates relative to the door 110, the roller 1104 contacts the door 110. With the roller 1104 engaged with an inside surface of the door 110, continued rotation of the bracket support 310 to the unfolded position causes the door 110 to be pushed away from the sliding assembly 312 and, thereby, the extendable hinge 600 to partially expand. In the partially expanded position, corresponding sides of the first bracket 314 and the third bracket 322 are spaced apart a distance C, which is greater than distance A and may be greater than distance B, and the arm 320 is oriented at an angle Z, which is greater than angle X and may be greater than angle Y. By virtue of angle Z being larger than angle X, and similar to the pre-open cam 402 and block 404, the manual force required on the door handle to transition the extendable hinge 600 from the partially expanded position to the fully expanded configuration at the second end 306 of the track 304 is less than the manual force required to transition the prior art hinge 300 from the collapsed position to the fully expanded position at the second end 306 of the track. In the event that angle Z is greater than angle Y (which may be possible by adjusting the location of the pre-open door bracket 1100 relative to the support bracket 310 via slots 1102), the manual force required for the second embodiment of the extendable hinge 600 may be less than the manual force required for the first embodiment of the extendable hinge 500. The ease of opening the extendable hinge 600 prevents a manual operator of the sliding door 110 to use excessive force that could cause damage to the vehicle 100, track 204, roller assembly 312, or bracket support 310.

The pre-open door bracket 1100 may be optimized by size and mounting along slots 1102 such that the maximum pre-expansion distance C can be achieved, while the pre-open door bracket 1100 can still stow in the OEM vehicle chassis pocket when the door 110 is closed.

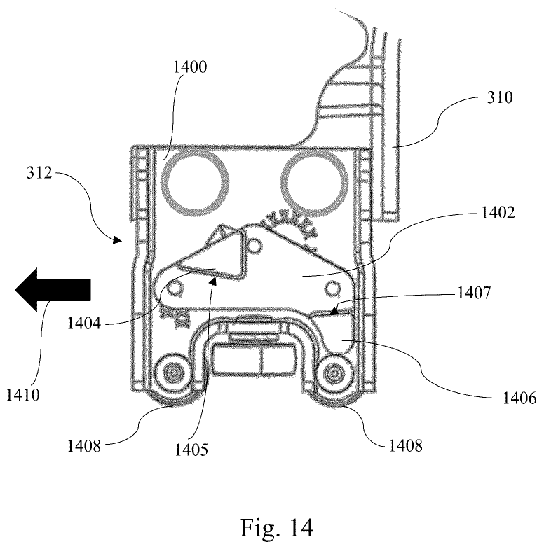

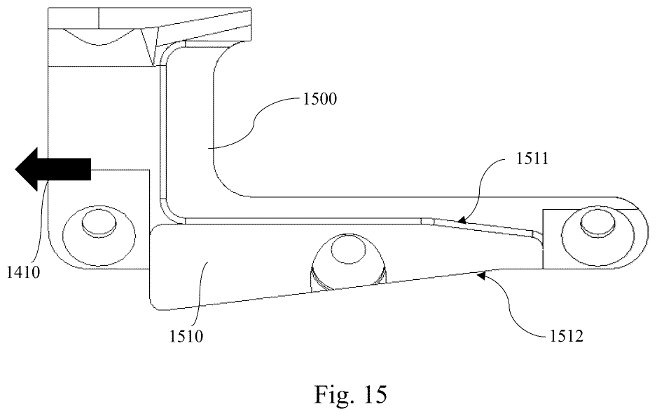

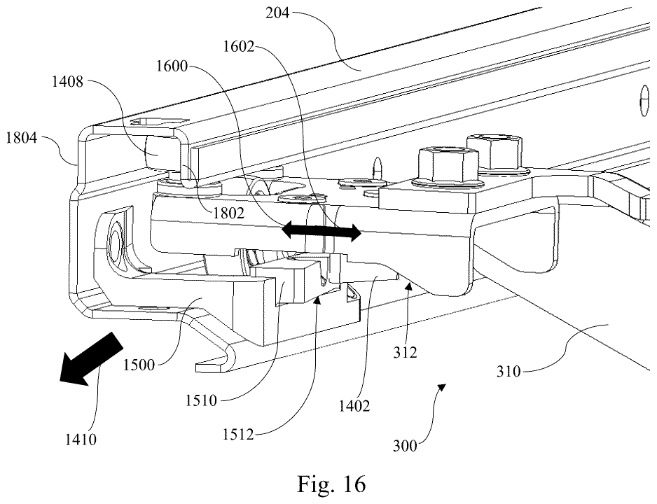

FIGS. 14-16 illustrates an improvement to the track 204 and roller assembly 312 that at least partially contains the forces (e.g., at least partially isolate forces from the rollers of roller assembly 312 and track 204) when any embodiment of the extendable hinges 300, 500, 600 transitions from a collapsed or partially expanded position to the fully expanded configuration at the second end 306 of the track 204. FIG. 14 illustrates a bottom view of the sliding assembly 312 having a sliding block 1402. FIG. 15 illustrates a top view of the wedge bracket 1500 configured to be mounted to track 204 at the second end 306. FIG. 16 is a perspective view showing the sliding block 1402 engaged with the wedge bracket 1500.

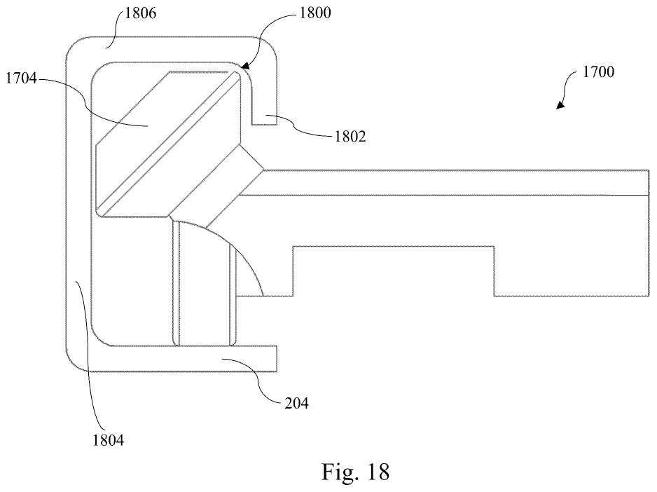

In the prior art roller assembly 312, two horizontal rollers 1408 are configured to contact a rear wall 1804 (shown in FIG. 18) and a front lip 1802 of the track 204. The transition of the extendable hinges 300, 500, 600 from the collapsed or partially expanded configuration to the fully expanded configuration creates a moment force wherein one of the rollers 1408 contacts the front lip 1802 of the track 204 and the other horizontal roller 1408 contacts the rear wall 1804 of the track 204. This moment force applied to the track 204 by the rollers 1408 may cause damage to the track 204. The damage can include bending the lip 1802 outwards, which may compromise the retainment of the rollers 1408 in future cycles of the extendable hinges 300, 500, 600.

Any extendable hinge 300, 500, 600 may be improved to include the block 1402 coupled to sliding assembly 312. The block 1402 is configured to engage with wedge bracket 1500 and contain the previously described moment force such that the spreading force exerted by rollers 1408 on the track 204 (between rear wall 1804 and lip 1802) is reduced or eliminated. Arrow 1410 defines the sliding direction of the sliding assembly 312 towards the second end 306 of track 204, or the door 110 open position. The improvement is the block 1402 fixedly mounted to the underside of the sliding assembly 312 base 1400. The block 1402 comprises at least one, or as shown in FIG. 14 two, protruding features 1404 and 1406. The protruding features 1404 and 1406 have interfacing edges 1405 and 1407. More than two protruding features are contemplated. The block and protruding features may also be integrated into the base 1400, instead of block 1402 that is separated formed and attached to the base 1400. The protruding features 1404 and 1406 are configured such that when the extendable hinge 300 is slid to the second end 306 of track 204, the protruding features 1404 and 1406 engage with the wedge bracket 1500. The wedge bracket 1500 has a protruding feature 1510. The protruding feature 1510 may have interfacing edges 1511 and 1512. Interfacing edges 1511 and 1512 are configured to receive and engage with interfacing edges 1405 and 1407, respectively. The contact between the block 1402 and wedge bracket 1500 provides horizontal support to sliding.

FIG. 16 illustrates a perspective view of the roller assembly 312 at the second end 306 of track 204. The wedge bracket 1500 may be coupled to the track 204 by one or more fasteners. The one or more fasteners may include a bolt, nut, threaded stud, weld nut, rivet, or any other known fasteners in the art. As the roller assembly 312 moves to the second end 306 of track 204, the block 1402 comes into contact with the wedge bracket 1500. It is contemplated that the block 1402 contacting the wedge bracket 1500 at the second end 306 of track 204 can function as the stop 308 configured to prevent the sliding assembly 312 from traveling further than desired in the track 204. The interfacing edges of the block 1402 and wedge bracket 1500 ensure the block 1402 is gradually aligned and bidirectionally supported along arrows 1600, 1602 when transitioning the extendable hinge into the fully extended configuration. In other words, engagement between interfacing edges 1407 and 1511 reduces or eliminates hinge expansion forces in direction 1602 from being transferred to the track 204, while engagement between interfacing edges 1405 and 1512 reduces or eliminates hinge expansion forces in direction 1600 from being transferred to the track 204. Stated in yet other terms, when roller assembly 312 is at the second end of the track 204, the protruding feature 1510 on the track defines a wedge that is received between interfacing edges 1405, 1407 on the roller assembly 312 to reduce or eliminate the magnitude of moment forces about a vertical axis being transferred to the track 204. In alternative embodiments, the same “wedging” action may be accomplished by providing the track 204 with two interfacing edges that capture a single wedge on the roller assembly 312.

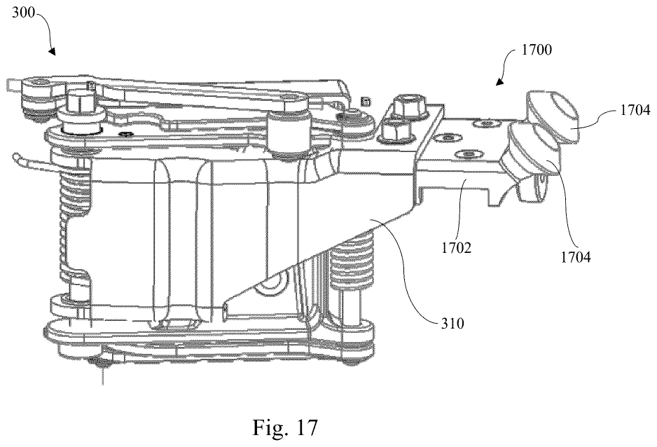

FIG. 17 illustrates a perspective of an improved roller assembly 1700 that is shown coupled to the prior art bracket support 310 and extendable hinge 300 in the first, collapsed and folded, configuration. However, it is contemplated that the improved roller assembly 1700 may be used with any extendable hinge, including the first and second embodiments of the improved extendable hinge 500, 600 described herein. A front view of the improved roller assembly 1700 is shown coupled to a track 204 in FIG. 18.

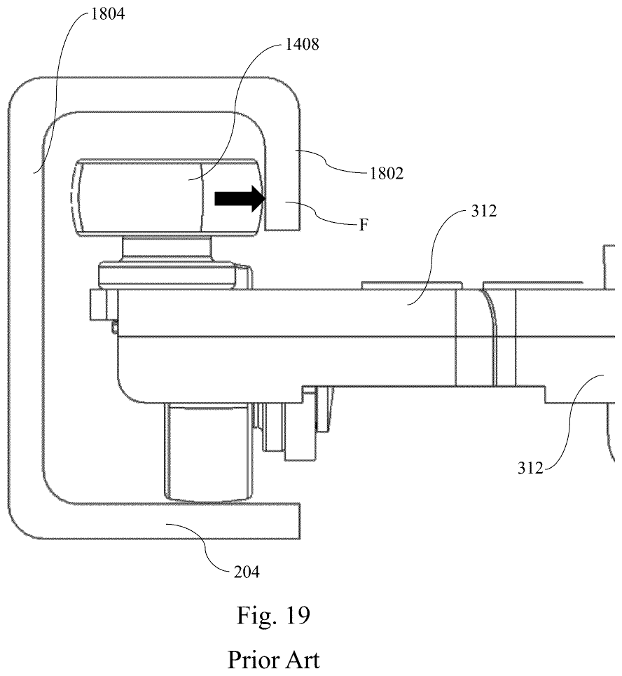

The improved roller assembly 1700 may comprise a custom base 1702 configured to rotatably mount at least one or more angled rollers 1704. The angled rollers 1704 can be described as having two tapered or conical portions, where the two portions define two roller surfaces that are oriented at an angle to each other meet at an apex. The apex can be configured engage with the corner 1800 of the track 204, between the lip 1802 and a top wall 1806, as shown in FIG. 18. The angled rollers 1704 allow at least some of the previously described moment force to be transferred to the inner corner 1800 when the extendable hinge is transitioning between a collapsed or partially expanded configuration to the fully expanded configuration at the second end 306 of track 204. The centralized force to the corner 1800 is better than the OEM, prior art sliding assembly 312 having one or more horizontal rollers 1408, that purely apply a horizontal force F to lip 1802 of track 204, as shown in FIG. 19. The horizontal force F applied to the cantilevered lip 1802 could cause the lip 1802 to be bent outwards. This could cause the sliding assembly 312 to fall out of the track 204 during operation if the lip 1802 is not in the proper location to retain the rollers 1408.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A motor vehicle, comprising:
a chassis;
a track coupled to the chassis, the track having a first end and a second end;
a door operatively connected to the track by a sliding assembly and adapted to move between a closed position and an open position, the door being in the closed position when the sliding assembly is at the first end and in the open position when the sliding assembly is at the second end;
an extendable hinge disposed between the sliding assembly and the door, the extendable hinge having a collapsed condition, a partially expanded condition, and a fully expanded condition; and
a pre-open mechanism coupled between the chassis and the door to move the extendable hinge from the collapsed condition to the partially expanded condition as the sliding assembly moves away from the first end and toward the second end of the track.

2. The motor vehicle of claim 1, wherein the extendable hinge comprises a first bracket mounted to the door, a second bracket, and a third bracket rotatably mounted to the sliding assembly; and the second bracket is rotatably mounted to the first bracket and to the third bracket.

3. The motor vehicle of claim 2, wherein: in the collapsed condition, the first bracket and third bracket are spaced a first distance apart; in the partially expanded condition, the first bracket and the third bracket are spaced a second distance apart; and the second distance is greater than the first distance.

4. The motor vehicle of claim 3, wherein: the extendable hinge further comprises an arm pivotably mounted to the first bracket and to the third bracket; in the collapsed condition, the arm is oriented at a first angle relative to the first bracket; in the partially expanded condition, the arm is oriented at a second angle relative to the first bracket; and the second angle is greater than the first angle.

5. The motor vehicle of claim 4, wherein the extendable hinge has a folded configuration relative to the sliding assembly when the sliding assembly is at the first end of the track and the door is in the closed position and transitions to an unfolded configuration relative to the sliding assembly as the sliding assembly moves away from the first end of the track.

6. The motor vehicle of claim 5, wherein the pre-open mechanism engages to move the extendable hinge from the collapsed condition to the partially expanded condition as the extendable hinge transitions from the folded configuration to the unfolded configuration.

7. The motor vehicle of claim 6, wherein the third bracket is nested with the sliding assembly when the extendable hinge is in the folded position and is generally perpendicular to the sliding assembly when the extendable hinge is in the unfolded position.

8. The motor vehicle of claim 7, wherein the sliding assembly comprises a roller assembly slidably coupled to the track and a support bracket rotatably mounted to the third bracket.

9. The motor vehicle of claim 8, wherein the pre-open mechanism comprises a first cam member configured to engage a second cam member and move the extendable hinge from the collapsed condition to the partially expanded condition as the door moves away from the first end of the track.

10. The motor vehicle of claim 9, wherein the sliding assembly comprises the first cam member.

11. The motor vehicle of claim 10, wherein the cam member is a surface.

12. The motor vehicle of claim 11, wherein the first bracket comprises the second cam member.

13. The motor vehicle of claim 12, wherein the second cam member is a surface.

14. The motor vehicle of claim 1, wherein, when the sliding assembly is disposed at the second end of the track, a first interfacing edge and a second interfacing edge of the track engage, respectively, with a corresponding first interfacing edge and a second corresponding interfacing edge of the sliding assembly.

15. The motor vehicle of claim 14, wherein the first interfacing edge and the second interfacing edge are defined by a wedge that is received between the first corresponding interfacing edge and the second corresponding interfacing edge.

16. The motor vehicle of claim 15, wherein the first corresponding interfacing edge and the second corresponding interfacing edge are defined by a wedge that is received between the first interfacing edge and the second interfacing edge.

17. A motor vehicle, comprising:
a chassis;
a track coupled to the chassis, the track having a first end and a second end;
a door operatively connected to the door track by a sliding assembly and adapted to move between a closed position and an open position, the door being in the closed position when the sliding assembly is at the first end and in the open position when the sliding assembly is at the second end; and
an extendable hinge disposed between the sliding assembly and the door, the extendable hinge having a collapsed condition when the sliding assembly is at the first end and the door is in the closed position, and the extendable hinge expanding to a fully expanded condition when the sliding assembly is at the second end whereby the door can move to the open position;
wherein, when the sliding assembly is disposed at the second end of the track, a first interfacing edge and a second interfacing edge of the track engage, respectively, with a corresponding first interfacing edge and a second corresponding interfacing edge of the sliding assembly.

18. The motor vehicle of claim 17, wherein the first interfacing edge and the second interfacing edge are defined by a wedge that is received between the first corresponding interfacing edge and the second corresponding interfacing edge.

19. The motor vehicle of claim 17, wherein the first corresponding interfacing edge and the second corresponding interfacing edge are defined by a wedge that is received between the first interfacing edge and the second interfacing edge.
